(19) United States
(12) Patent Application Publication
(10) Pub. No.: US 2024/0028885 A1
(43) Pub. Date: Jan. 25, 2024

(54) Method and System for Instilling Shape-Awareness to Self-Supervised Learning Domain

(71) Applicant: NavInfo Europe B.V., Eindhoven (NL)

(72) Inventors: Shruthi Gowda, Eindhoven (NL); Bahram Zonooz, Eindhoven (NL); Elahe Arani, Eindhoven (NL)

(21) Appl. No.: 17/894,870

(22) Filed: Aug. 24, 2022

(30) Foreign Application Priority Data
Jul. 22, 2022 (NL) 2032580

(51) Int. Cl. G06N 3/08; G06N 3/04; G06T 7/13; G06V 10/74

(52) U.S. Cl. CPC G06N 3/08; G06N 3/0454; G06T 7/13; G06V 10/761; G06T 2207/20081; G06T 2207/20084

(57) ABSTRACT

A computer-implemented method of self-supervised learning for deep neural networks including the steps of: providing input images (x); extracting implicit shape information from the input images; and performing self-supervised learning on at least two deep neural network (f) based on the provided input images (x) and the at least one extracted implicit shape information for enabling said at least one deep neural network (f) to classify and/or detect objects within other input images.

### CROSS-REFERENCE TO RELATED APPLICATIONS

This application claims priority to and the benefit of Netherland Patent Application No. 2032580, titled “Method and System for Instilling Shape-Awareness to Self-Supervised Learning Domain”, filed on Jul. 22, 2022, and the specification and claims thereof are incorporated herein by reference.

### BACKGROUND OF THE INVENTION

### Field of the Invention

The invention relates to a computer-implemented method for instilled shape awareness supported self-supervised learning for deep neural networks.

### Background Art

Deep neural networks (DNN) encode patterns in data distribution to produce rich and powerful representations that have resulted in improved generalization performance across various perception tasks. These tasks include, but aren't limited to classification, detection and segmentation. In one example image data can be annotated by means of a DNN to reflect a classification or detected property of, or within, the image. Representations are in essence useful information for classification or prediction in a general sense. Useful information here being any information that allows for the detection of similar properties, such as objects, parts of objects, scenarios, environmental settings, etc., within a plurality of different images. To this end a DNN may be trained through manual assistance, where a user annotates the data so as to provide the DNN with a training set or a correction during learning.

A disadvantage of current networks is that these can be data hungry which makes manually providing annotations both costly and cumbersome.

Presently, self-supervised learning (SSL) approaches are used to forego the need of costly manual annotations. In SSL the network is, in simple terms, taught representations by getting supervision from the data samples themselves. Various SSL techniques have been proposed, but the difficulty of DNNs to learn high-level and generic features instead of relying on local and spurious cues in the data is still a prevalent problem. For a network to learn ‘better’, that is to say higher-level, representations, embodiments of the present invention arrange networks so as to look beyond local cues and instead to global semantic information. It is for the purpose of the invention postulated that the mammalian brain, in particular the human brain, is able to extract global semantic information with ease. This ability would be owing to pre-stored templates, or ‘cognitive bias’. Adding this prior knowledge into SSL methods can help enhance the generalization and robustness of the networks.

More specifically a goal of the invention is to enable the SSL to produce generic and high-level representations that can be used to support different downstream tasks. SSL, such as with prior learning, can here also be seen as the ‘pretraining stage’ for deep neural networks. In SSL unlabeled data is taken as input to train the deep neural network such that it learns generic representations. This trained network can be further used for classification or detection applications. In one example, the neural network according to the method of the invention may be provided to receive an image data stream of the camera of a vehicle, and wherein the neural network is able to produce generic and high-level representations within images of the data stream of said camera. To this end the vehicle may be arranged so as to transmit images to a distant server operating the neural network, or wherein the neural network is provided within an on-board computer of the vehicle. In such systems it may be particularly useful to attribute certain representations to an image. In one example the network may decide that an image represents a child. The more accurate recognition of such a distinction is beneficial as this further allows for an action, such as a warning or automatic braking, to be performed by the vehicles. To this end the vehicle would be a semi-autonomous or fully autonomous vehicle. Various SSL techniques have been proposed that continue to reduce the gap between supervised and self-supervised learning. These approaches are listed as follows:
1. Matthias Minderer, Olivier Bachem, Neil Houlsby, and Michael Tschannen. Automatic shortcut removal for selfsupervised representation learning. In International Conference on Machine Learning, pp. 6927-6937. PMLR, 2020.
2. Joshua Robinson, Li Sun, Ke Yu, Kayhan Batmanghelich, Stefanie Jegelka, and Suvrit Sra. Can contrastive learning avoid shortcut solutions? Advances in Neural Information Processing Systems, 34, 2021.
3. Shlok Mishra, Anshul Shah, Ankan Bansal, Jonghyun Choi, Abhinav Shrivastava, Abhishek Sharma, and David Jacobs. Learning visual representations for transfer learning by suppressing texture. arXiv preprint arXiv:2011.01901, 2020.
4. Songwei Ge, Shlok Mishra, Chun-Liang Li, Haohan Wang, and David Jacobs. Robust contrastive learning using negative samples with diminished semantics. Advances in Neural Information Processing Systems, 34, 2021.
5. Gowda, Shruthi, Bahram Zonooz, and Elahe Arani. “InBiaseD: Inductive Bias Distillation to Improve Generalization and Robustness through Shape-awareness”. Conference on Lifelong Learning agents (CoLLAs 2022)
6. Irwin Sobel and Gary Feldman. A 3×3 isotropic gradient operator for image processing. a talk at the Stanford Artificial Project in, pp. 271-272, 1968. However, the approaches still show disparity with humans on what they focus on to create representations.

To the above end the invention proposes a computer-implemented method comprising utilizing implicit information already existing within data, such as a data stream, to enhance the representation capability.

This application refers to a number of references. Such references are provided and discussed for purposes of a more complete background and is not to be construed as an admission that such references are prior art for patentability determination purposes.

### BRIEF SUMMARY OF THE INVENTION

According to a first aspect of the invention there is provided a method comprising the steps of:
(i) providing input images;
(ii) extracting implicit shape information from the input images; and
(iii) performing self-supervised learning on at least two deep neural networks based on the provided input images (x) and the at least one extracted implicit shape information for enabling said at least two deep neural network to classify and/or detect objects within other input images, such as in a separate application after the self-supervised learning is completed. This could be any one of road condition monitoring, road signs detection, parking occupancy detection, defect inspection in manufacturing, insect detection in agriculture, aerial survey and imaging and many more.

Beneficially, step (iii) can be performed by a base Siamese network designed for processing mutually different input image views derived from the same input images. This allows the same pretrained encoder to be used for mutually different downstream purposes, and allows in one example for both classification and object detection. Performing self-supervised learning within two mutually different views of the input image, while also providing supervision from the prior knowledge (shape) data from the prior network reduces overfitting to local trivial solutions and helps generate high level representations.

Further beneficially, the base Siamese network may comprise a plurality of first encoders (f(θ)) and a second encoder (f′(θ)), wherein the second encoder (f′(θ)) is fed an image view transformed by the extracted implicit shape information, and wherein the plurality of first encoders are fed the mutually different input image views and wherein the plurality of first encoders the second encoder are convolutional neural networks. This allows for symmetric and asymmetric updates of the Siamese network and beneficially enforces the network to learn to incorporate the global semantic information found within the images.

In yet another example parameters, such as coefficients, of the Siamese network can be updated asymmetrically, in a way that the network parameters of the Siamese network are updated for one augmented input image view, while considering the features of another augmented input image view as the target.

Additionally, and/or alternatively, a Sobel filter can be used for extracting implicit shape information from the input images.

In a more specific example, the method may comprise the use of a first predictor downstream of one encoder of the plurality of first encoders and a second predictor downstream of the second encoder, and wherein optionally extracting implicit shape information comprises the use of a Kullback-Leibler divergence between predictor outputs of the first and second predictors.

In yet another example, negative cosine similarity can be used as a similarity objective function, and a Simsiam SSL loss is then used to calculate the losses received by each of the plurality first encoders, and wherein the losses are combined to formulate a symmetric loss using stop gradients.

According to a second aspect of the invention there is provided a data processing apparatus comprising means for carrying out the method according to the first aspect of the invention.

According to a third aspect of the invention there is provided a computer program product comprising instructions which, when the program is executed by a computer, cause the computer to carry out the method according to the first aspect of the invention.

According to a fourth aspect of the invention there is provided an at least partially autonomous driving system comprising at least one camera designed for providing a feed of input images, and a computer designed for classifying and/or detecting objects using a deep neural network, wherein said deep neural network has been trained using a self-supervised learning method according to the first aspect of the invention.

Beneficially, the network can be designed for outputting driver responses, such as braking, for piloting the system in response to a predefined classification and/or detection within the feed of images.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more embodiments of the invention and are not to be construed as limiting the invention. In the drawings:

FIG. 1 is a schematic illustration showing the architecture of an SSL-prior trained network according to an embodiment of the present invention;

FIG. 2 is a schematic illustration of the inversion of the stop gradient with the architecture according to FIG. 1, according to an embodiment of the present invention; and

FIG. 3 is a schematic illustration showing downstream applications of a trained deep neural network f, according to an embodiment of the present invention.

### DETAILED DESCRIPTION OF THE INVENTION

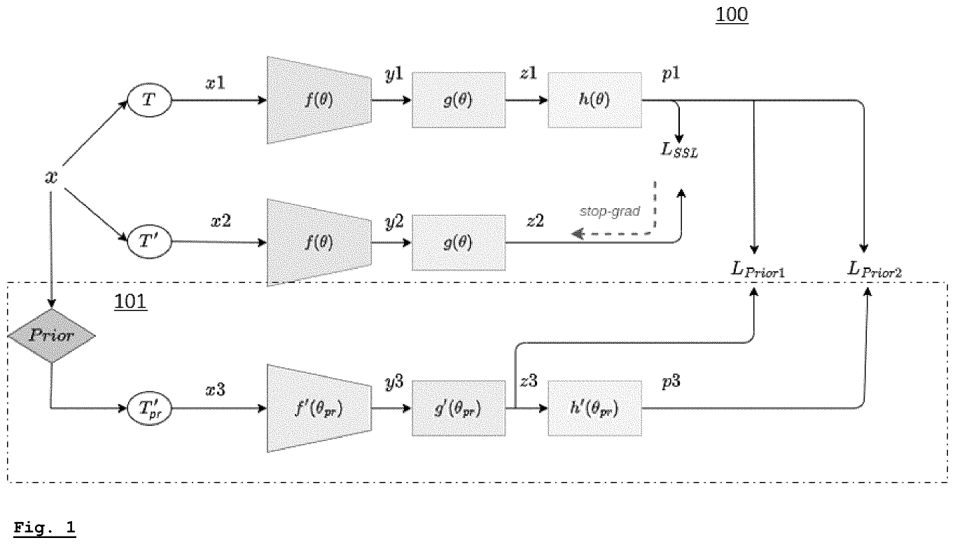

Embodiment of the present invention provide an approach to integrate prior knowledge into the self-supervised training framework to propel the deep neural networks to learn better representations, in particular shape. It is noted that representations here are semantically meaningful representations that can constitute detecting the type of environment, such as a road environment (highway, interstate, rural, or residential), whether a road is busy, but also detecting objects within an image, such as pedestrians, cyclists, vehicles, and even type of vehicles and even between images of the image is part of an image stream, the direction of movement relative to the perspective of a camera providing the image stream. In FIG. 1 a training domain 100 is shown. The network being trained is here shown as a first encoder f. The first encoder f is shown multiple times within the same domain, which is a characteristic of a base Siamese network. Network f is trained via SSL and further used in downstream tasks, such as classification and object detection. The networks f help enrich the representations learnt and aid in better generalization and robustness in the downstream tasks. The domain 100, also called the architecture of ‘SSL-Prior’ consists of such a base Siamese network. Siamese networks are a class of neural network architecture that contains multiple identical networks. Identical here means that network f actually constitutes a plurality of networks f sharing the same configuration and parameters, but process two different inputs. These can therefore be used to find similarities between mutually different inputs. In this method the input x is augmented so as to produce three different image views x1, x2, x3, two of which x1 and x2 are each fed as input to the first encoders f and the third x3 is fed to the second encoder f′. It can be seen from FIG. 1 that the architecture 100 also comprises a projector g associated with each of the first encoders f which is designed to project the output y1 of one view to match the output y2 of another view. The predictor h further helps the projections adapt better to the representations of the other view. This objective between similar images, but with different data transformations, helps the network learn representations of the image.

Given a sample of input images x, the present invention creates augmented views of the input images by applying augmentations, also known as transformations. T and T′ are augmentations from a set of augmentations. It is noted that the term f(θ) is simply f using x1, x2 as input.

SSL used an extensive set of augmentations to induce invariances. These augmentation comprise randomized cropping of the input images, a randomized change of brightness, contrast and/or saturation of an image, a randomized adjustment of the grayscale of the input images, and a random horizontal flipping of the image. While training is improved, the invention proves effective even with just randomized cropping and randomized flipping of the image only. In essence the above are exampled for different input images to be derived from the same input images through randomized augmentation.

As to FIG. 1, T and T′ are applied to input x to produce the views x1 and x2. x1=T(x); x2=T′(x), thus representing mutually different random transformations of the original input images x.

To recapitulate. In FIG. 1, the architecture 100 comprises first encoders f, which are convolutional neural networks (CNNs). Also separate from this example the first and second encoders are themselves designed according to a standard Resnet-18 architecture. The projector associated with the first encoder g is a 2-layer multilayer perceptron (MLP) network comprising two Batch norm layers. The predictor h is also a 2-layer MLP with one batch norm layer. The prior framework 101 has a setup with a second encoder f′, a projector g′ and a predictor h′.

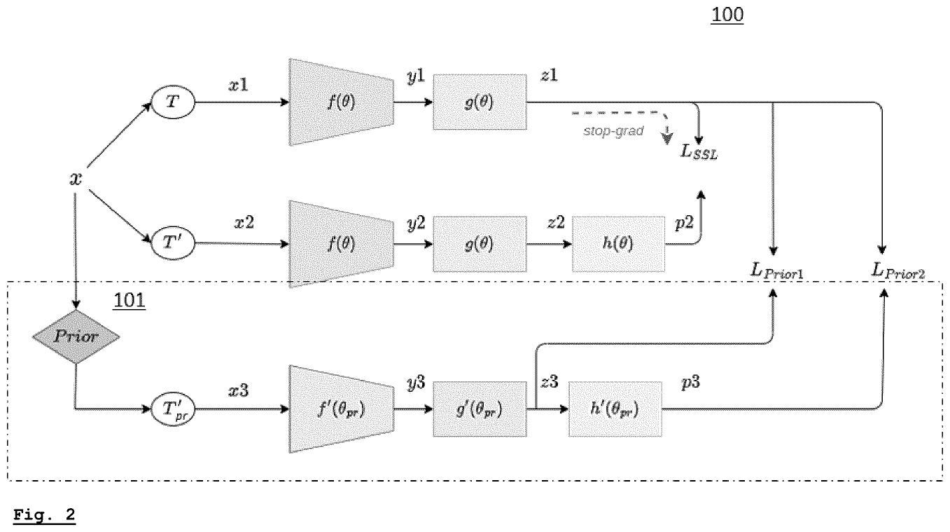

In FIG. 2 the same architecture 100 as show in FIG. 1. The only difference is that the predictor h is used downstream of a mutually different first encoder f, with respect to FIG. 1. In other words, the architecture allows for asymmetric updates in reversible direction. Also separate from this example. In this manner a symmetric loss for the self-supervised learning L_{SSL} can be determined for the sum of the asymmetric updates. More in detail below:

According to FIG. 1
The Encoder outputs for the two augmented views are:
y1=f(x1; θ) and y₂=f(x₂;θ);
The projector output: z₂=g(y₂;θ)
and the predictor output p₁=h(z₁;φ)

$$D ( {p}_{1} , {z}_{2} ) = - \frac{{p}_{1}}{‖ {p}_{1} ‖} \cdot \frac{{z}_{2}}{‖ {z}_{2} ‖}$$

According to FIG. 2
The projector output: x₁=g(y₁;θ)
and the predictor output: p₂=h(z₂;φ)

$$D ( {p}_{2} , {z}_{1} ) = - \frac{{p}_{2}}{‖ {p}_{2} ‖} \cdot \frac{{z}_{1}}{‖ {z}_{2} ‖}$$

The asymmetric losses can be combined to from L_{SSL}:

$${L}_{SSL} = \frac{1}{2} D ( {p}_{1} , {z}_{2} ) + \frac{1}{2} D ( {p}_{1} , {z}_{2} )$$

More generically the function can be written as follows:

$${ℒ}_{ssl} = {\sum }_{i , j ∈ \{ 1 , 2 \} ; j \neq i} \frac{{p}_{i}}{‖ {p}_{i} ‖} \cdot \frac{{z}_{j}}{‖ {z}_{j} ‖}$$

To induce the prior knowledge, the present invention aims to train the second encoder network f′, by utilizing the shape or the global semantic information. It is possible to extract the implicit shape information to generate the prior image xₚᵣ. The architecture 100 thus applies a prior transformation to produce xₚᵣ.

In one example a Sobel filter can be chosen for the prior, that is to say for the second encoder. The algorithm of the Sobel filter is explained below:

Algorithm 1 Sobel Edge Detection Algorithm
Input: Input image X

| | |
|---|---|
| 1: | Up-sample the images to twice the original size: 1 = Upsample(X) |
| 2: | Apply Gaussian smoothing to reduce noisy edges: I_{D} = |
| | Gaussian_Blur(I, kernel_size = 3) |
| 3: | $Get Sobel kernels : {G}_{x} = [ \begin{matrix}- 1 & 0 & + 1 \\ - 2 & 0 & + 2 \\ - 1 & 0 & + 1\end{matrix} ] and {G}_{y} = [ \begin{matrix}- 1 & - 2 & - 1 \\ 0 & 0 & 0 \\ + 1 & + 2 & + 1\end{matrix} ]$ |
| 4: | Apply Sobel kernels: I_{dx} = I_{b} * Gₓ and I_{dy} = I_{b} * G_{y} |
| | where * here denotes the 2-dimentional signal processing |
| | convolution operation |
| 5: | The edge magnitude: Iₛₕₐₚₑ = \sqrt{I_{dx}² + I_{dy}²} |
| 6: | Down-sample to original image size: Iₛₕₐₚₑ = Downsample(Iₛₕₐₚₑ) |

In the Sobel filter the input images are up-sampled to twice their original size, gaussian smoothing is applied, Sobel kernels are applied to the up-sampled images (denoting 2-dimensional signal processing in a convolution operation), a magnitude of an edge of objects within the image is determined, and the images are down-sampled to the original image size.

In the flow diagram, or architecture 100 according to both FIGS. 1 and 2 a transformation Tis applied to xₚᵣ

x3=T′pr(xₚᵣ)

In other words, also separately from this example, xₚᵣ is used to produce x3 via transformation T′ₚᵣ.

T′ here being T′ₚᵣ One network looks at the original images (texture) x, albeit with its own randomized augmentations x1, x2, while other network focuses on the semantic information. Training these two networks in synchrony with aligning objective functions will reduce overfitting and encourage the network to explore the latent space to produce generic representations.

The prior network produces representations rich in shape and we use this to supervise the network.

Optionally, yet with some preference, embodiments of the present invention can employ two different losses to induce shape supervision into the network.

First (i) is the negative cosine similarity D to maintain consistency between original and the shape aware feature representations. This beneficially allows the shape view to regularize the representations and enforce the network to learn to incorporate the global semantic information. The SSL prior loss is also an asymmetrical loss and is given as:

$${L}_{Prior 1} = \frac{1}{2} D ( {p}_{1} , {z}_{3} ) + \frac{1}{2} D ( {p}_{3} , {z}_{1} )$$

$${L}_{Prior 1} = {\sum }_{i , j ∈ \{ 1 , pr \} ; j \neq i} \frac{{p}_{i}}{‖ {p}_{i} ‖} \cdot \frac{{z}_{j}}{‖ {z}_{j} ‖}$$

Secondly (ii) there may be added an additional loss to distil the shape knowledge by employing a Kullback-Leibler divergence (KL loss) between the predictor outputs. KL divergence is used in literature to measure the difference between two probability distributions over the same variable. As this is done in the prediction space, the distributions can be aligned to further guide the network to make decisions that are less susceptible to trivial shortcut cues.

L_{Prior2}= [symbol] _{KL}(softmax(p₁)∥softmax(p₂))

The complete Prior loss is the sum of both the prior losses:

[symbol] ₛₛₗ₋ₚᵣᵢₒᵣ= [symbol] _{Prior1}+λₚᵣ [symbol] _{Prior2}

The overall loss is the combination of the self-supervised loss and the prior knowledge loss. The SSL loss learns invariant representations between two views of standard images while the SSL-Prior loss regularizes and supervised the training to focus on the relevant, semantic and meaningful features, to move towards a biologically plausible representation learning.

[symbol]

= [symbol] ₛₛₗ+λ [symbol] ₛₛₗ₋ₚᵣᵢₒᵣ

λ and λₚᵣ are the loss balancing factors.

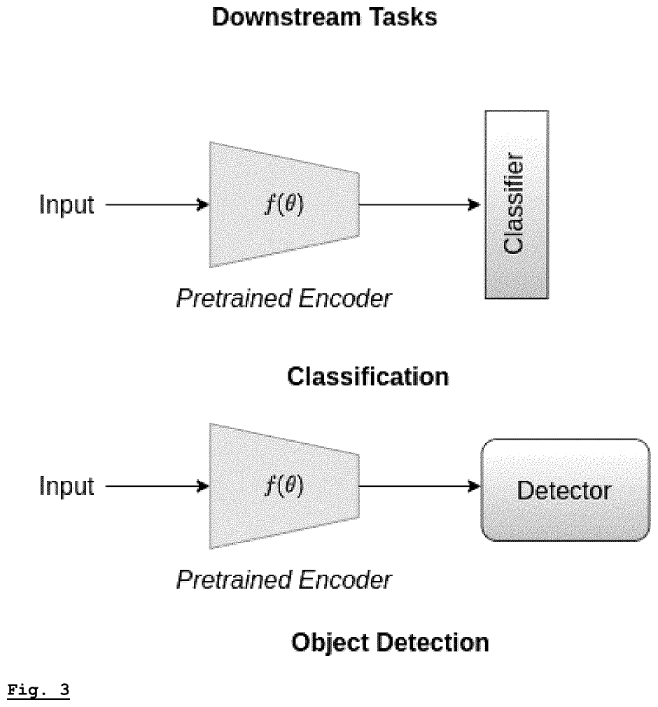

FIG. 3 shows downstream applications of pre-trained networks f using the method of the invention.

Lastly, it is mentioned that psychophysical experiments have shown that networks rely on texture while humans focus more on global semantic information. But reliance on spurious cues leads to shortcut learning, which is a challenging problem that is also prevalent in SSL settings. Reliance of networks on shortcuts, that are trivial cues in training data but that do not translate to other settings, results in lower generalization performance. This simplicity bias presents a challenge even in the SSL. Moreover, all the SSL techniques rely on an extensive set of augmentations to enforce multiple invariances into the learned representations and the augmentations can be viewed as a double-edged sword, that and can be beneficial or detrimental depending on the downstream application.

To learn better representations, the invention aims to guide networks to look beyond the local cues to generate high level and meaningful representations. The cognitive bias or the pre-stored template in the brain aids in this task. This prior is implicit and can add supervision to enable taking accurate decisions. The present invention thus aims to enable SSL to be more biologically plausible to result in better representations.

Typical application areas of the invention include, but are not limited to:
Road condition monitoring
Road signs detection
Parking occupancy detection
Defect inspection in manufacturing
Insect detection in agriculture
Aerial survey and imaging

Although the invention has been discussed in the foregoing with reference to an exemplary embodiment of the method of the invention, the invention is not restricted to this particular embodiment which can be varied in many ways without departing from the invention. The discussed exemplary embodiment shall therefore not be used to construe the append-ed claims strictly in accordance therewith. On the contrary the embodiment is merely intended to explain the wording of the appended claims without intent to limit the claims to this exemplary embodiment. The scope of protection of the invention shall therefore be construed in accordance with the appended claims only, wherein a possible ambiguity in the wording of the claims shall be resolved using this exemplary embodiment.

Embodiments of the present invention can include every combination of features that are disclosed herein independently from each other. Although the invention has been described in detail with particular reference to the disclosed embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference. Unless specifically stated as being “essential” above, none of the various components or the interrelationship thereof are essential to the operation of the invention. Rather, desirable results can be achieved by substituting various components and/or reconfiguration of their relationships with one another.

Optionally, embodiments of the present invention can include a general or specific purpose computer or distributed system programmed with computer software implementing steps described above, which computer software may be in any appropriate computer language, including but not limited to C++, FORTRAN, ALGOL, BASIC, Java, Python, Linux, assembly language, microcode, distributed programming languages, etc. The apparatus may also include a plurality of such computers/distributed systems (e.g., connected over the Internet and/or one or more intranets) in a variety of hardware implementations. For example, data processing can be performed by an appropriately programmed microprocessor, computing cloud, Application Specific Integrated Circuit (ASIC), Field Programmable Gate Array (FPGA), or the like, in conjunction with appropriate memory, network, and bus elements. One or more processors and/or microcontrollers can operate via instructions of the computer code and the software is preferably stored on one or more tangible non-transitive memory-storage devices.

1. A computer-implemented method for instilled shape awareness supported self-supervised learning domain for deep neural networks, the method comprising the steps of:
(i) providing input images (x);
(ii) extracting implicit shape information from the input images; and
(iii) performing self-supervised learning on at least two deep neural network based on the provided input images (x) and the at least one extracted implicit shape information for enabling each of said at least two deep neural networks to classify and/or detect objects within other input images, such as in a separate application after the self-supervised learning is completed.

2. The method according to claim 1, further comprising designing the at least two deep neural networks as a base Siamese network, and wherein step (iii) is performed by said base Siamese network designed for processing mutually different input image views derived from the same input images through randomized augmentation.

3. The method according to claim 2, wherein the base Siamese network comprises a plurality of first encoders (f) and a second encoder (f), wherein the second encoder (f′) is fed an image view (x₃) transformed by the extracted implicit shape information, and wherein the plurality of first encoders are fed the mutually different input image views (x₁, x₂) and wherein the plurality of first encoders and the second encoder are convolutional neural networks.

4. The method according to claim 2, further comprising updating parameters of the Siamese network asymmetrically, in a way that the network parameters of the Siamese network are updated for one augmented input image view, while considering the features of another augmented input image view as the target.

5. The method according to claim 1, further comprising using a Sobel filter for extracting implicit shape information from the input images.

6. The method according to claim 3, further comprising:
using a first predictor (h) downstream of one encoder of the plurality of first encoders (0 and a second predictor (h′) downstream of the second encoder (f′); and
using a Sobel filter for extracting implicit shape information from the input images using a Kullback-Leibler divergence between predictor outputs (p1, p2) of the first and second predictors (h, h′).

7. The method according to claim 6, further comprising:
using a negative cosine similarity (D) as a similarity objective function;
using a Simsiam SSL loss to calculate the losses received by each of the plurality of first encoders (f); and
combining the losses to formulate a symmetric loss using stop gradients.

8. The method according to claim 6, further comprising choosing a method architecture so that an overall loss for the training of a deep neural network using the method is the combination of a self-supervised loss and a prior knowledge loss.

9. A data processing apparatus comprising means for carrying out the method of claim 1.

10. A computer program product comprising instructions which, when the program is executed by a computer, cause the computer to carry out the method of claim 1.

11. An at least partially autonomous driving system comprising at least one camera designed for providing a feed of input images, and a computer designed for classifying and/or detecting objects using a deep neural network (f), wherein the deep neural network has been trained using a self-supervised learning method according to claim 1.

12. The system according to claim 11, wherein the driving system is designed for outputting driver responses for piloting the system in response to a predefined classification and/or detection within the feed of images by the deep neural network (f).

13. The system according to claim 11, wherein the driver response is braking.

14. The method according to claim 3, wherein parameters of the Siamese network are updated asymmetrically, in a way that the network parameters of the Siamese network are updated for one augmented input image view, while considering the features of another augmented input image view as the target.

15. The method according to claim 7, further comprising choosing a method architecture so that an overall loss for the training of a deep neural network using the method is the combination of a self-supervised loss and a prior knowledge loss.

16. The method according to claim 3, wherein the parameters are coefficients.

17. The method according to claim 14, wherein the parameters are coefficients.
